(19) United States
(12) Patent Application Publication
(10) Pub. No.: US 2026/0048445 A1
(43) Pub. Date: Feb. 19, 2026

(54) METHOD FOR HARD-FINISHING A WORKPIECE HAVING A GEARING OR A PROFILE ON A HARD-FINISHING MACHINE

(71) Applicant: KAPP NILES GmbH & Co. KG, Coburg (DE)

(72) Inventors: Christopher GOEBEL, Ahorn (DE); Johannes RITZ, Sonnefeld (DE); Jan SENFTLEBEN, Coburg (DE)

(21) Appl. No.: 19/235,869

(22) Filed: Jun. 12, 2025

(30) Foreign Application Priority Data
Aug. 19, 2024 (DE) 10 2024 123 550.0

(51) Int. Cl. B23F 1/02

(52) U.S. Cl. CPC B23F 1/02

(57) ABSTRACT

A method for hard-finishing a workpiece on a hard-finishing machine, wherein the hard-finishing machine has a number of machine axes. The workpiece is received on a workpiece spindle and is machined by a tool received on a tool spindle. During a temporal segment of the machining phase in which the tool is not in engagement with the workpiece, a test run is carried out on at least one machine axis. The machine axis is driven during the test run. A value is specified for at least one drive parameter for which a nominal value of the movement of the machine axis is expected. The actual value of the movement of the machine axis is detected, a comparison between the nominal value and the actual value is carried out by a monitoring device, and a signal is output by the monitoring device if the difference between the nominal value and the actual value lies outside an admissible range.

### CROSS-REFERENCE TO RELATED APPLICATIONS

The present application claims priority of DE 10 2024 123 550.0, filed Aug. 19, 2024, the priority of this application is hereby claimed, and this application is incorporated herein by reference.

### BACKGROUND OF THE INVENTION

The invention relates to a method for hard-finishing a workpiece having a gearing or a profile on a hard-finishing machine, wherein the hard-finishing machine has a number of machine axes which are actuated under NC control for machining the workpiece, in which method the workpiece is received on a workpiece spindle and is machined by means of a tool received on a tool spindle machined by bringing the tool into engagement with the workpiece, wherein the workpiece machining phase begins with the introduction of the workpiece into the hard-finishing machine and ends with the removal of the machined workpiece from the hard-finishing machine.

A generic method is known from EP 3 168 700 A1. In this method, a workpiece is machined in a known manner under numerical control, in which the tool is brought into engagement with the workpiece to be machined, in particular with the workpiece to be ground. In addition to the actual machining time, various non-productive times occur, for example for loading and unloading workpieces and for dressing a grinding tool.

The hard-finishing machine is subject to wear due to operation, so that machine maintenance must be carried out in due course and machine components replaced if necessary. The same applies, for example, in the event of an unexpected event (e.g. crash, overload). Care must be taken to ensure that workpieces are not produced while the machine is no longer in proper condition due to wear or damage.

In practice, therefore, it is usual to conduct periodic reference runs of the machine to check the machine's status and in particular to assess wear, wherein during these reference runs, the machine axes (linear axes/rotary axes) are moved outside of the machine's actual operation and the response to specified control signals is recorded. This makes it possible to check whether the machine components involved are still in perfect condition or whether changes in the response to specified control signals have already been detected due to wear. In the latter case, appropriate machine maintenance is then required.

The cyclic reference runs that are carried out provide a very accurate picture of the machine condition. Exact results are obtained because exact process movements can be carried out under similar conditions during the reference runs, thus ensuring that disruptive influencing variables have only a very minor impact on the system.

The disadvantage, however, is that it depends on the selected period during which the reference runs are carried out, how closely changes to the machine can be determined. In practice, reference runs are not carried out too frequently due to the time required for this (since no workpieces can be machined during this time), which then, however, leads to relatively long phases in which the machine is not checked (long periods between reference runs). Longer reference runs can also lead to problems in the temperature behaviour of the machine.

### SUMMARY OF THE INVENTION

The underlying problem of the invention is to develop a process of the type mentioned above in such a way that improved condition monitoring of the hard-finishing machine and, in particular, its machine components, especially the linear and rotational axes, is possible. The aim is to achieve the most closely meshed machine monitoring possible without any loss of machine capacity. Furthermore, the aim is to detect possible causes of wear more accurately.

The solution of this problem by the invention is characterised in that at least in a temporal segment of the machining phase in which the tool is not in engagement with the workpiece, a test run is carried out on at least one machine axis, wherein the machine axis is driven during the test run, wherein a value is specified for at least one drive parameter for which a nominal value of the movement of the machine axis is expected, wherein the actual value of the movement of the machine axis is detected, wherein a comparison between the nominal value and the actual value is carried out by a monitoring device, and wherein a signal is output by the monitoring device if
a) the comparison between the nominal value and the actual value has shown that the difference between the nominal value and the actual value is outside of an admissible range, or
b) the comparison between the nominal value and the actual value has shown that the difference between the nominal value and the actual value has a value that, compared to previously recorded values of the difference, indicates that the difference has left an admissible tolerance range.

In this respect, an operating parameter is specified for at least one machine axle during the said test run and the reaction of the same to the operating parameter is recorded; a signal is emitted if a deviation between an expected value (nominal value) and the measured value (actual value) leaves a permissible range (case a). However, a trend analysis can also be carried out in exactly the same way, in which values recorded during previous test runs are included in order to determine whether the machine axis is about to leave an acceptable operating range (case b).

The at least one temporal segment of the machining phase preferably lies within the time interval in which the workpiece is held on the workpiece spindle. However, other temporal segments of the machining cycle can also be considered here, for example, temporal segments in which balancing or dressing takes place.

Regarding the nomenclature used here, it should be noted that a “test run” (especially as mentioned above) is to be understood as the described monitoring of a machine axis during the regular machining process of a workpiece—although this only occurs for sub-processes of the machining in which the tool does not engage with the workpiece—while a “reference run” is a separate test run of the (complete) machine axes, which is carried out outside the machining process of a workpiece.

The test run preferably takes place during an idle stroke in which the tool is moved relative to the workpiece without the tool engaging with the workpiece. Another preferred option is to perform the test run during an acceleration or rotational acceleration process and/or during a braking process of a machine axis. Of course, other sections of the machining cycle are also possible, such as turning a rotary table or dressing.

The test run is preferably carried out during a dressing phase in which the tool is profiled and/or during a phase in which the workpiece is aligned for machining in the hard-finishing machine and/or during a phase in which a balancing operation is carried out and/or during a phase in which a loading or unloading operation is carried out.

A further embodiment provides that the signal is not output until a statistical analysis and/or another evaluation of a number of recorded values has been carried out. This is to prevent a signal from being output during the test run when there is just one “outlier”. The statistical evaluation mentioned is generally understood to mean a (further) analysis of the detected data, which shows trends that emerge in the recorded data.

The proposed method is particularly advantageous when artificial intelligence (AI) is used. In particular, the assessment of the recorded values can be carried out in this context using an algorithm that takes into account feedback (or empirical values) in the context of “machine learning” (ML).

The value detected is preferably the acceleration recorded by an accelerometer and/or the current used to drive a machine axis and/or a control difference that occurs when controlling the machine axis and/or a signal that provides an indication of a deviation between the nominal and actual value.

In the case of acceleration measurement, a beginning deterioration in operation can be inferred from correspondingly low values or from a signal deviating from calculated or known progressions in the time and/or frequency range. If the current used to drive a machine axis increases significantly when a target movement is specified (in the time and/or frequency range), this can also be taken as an indication of increased wear. This also applies in the case of the control difference, which the controller has to compensate for; if increased values of the control difference occur here (in the time and/or frequency range), it can be concluded that the controller finds it more difficult to maintain the specified position due to wear. It should be noted that the evaluated and monitored signals can be viewed in both the time and frequency range.

The output of the monitoring device signal can, in the event that the assessment shows that the value is outside an acceptable range, trigger a reference run of the hard-finishing machine in which all machine axes are actuated without the tool coming into contact with the workpiece. Accordingly, the signal triggers a reference run for the machine if abnormalities are detected during one or more test runs.

The proposed method is used preferably in gear grinding.

The proposed concept can be used to determine the state of the machine and in particular the machine components during a machining cycle of a workpiece, thus enabling close and time-neutral monitoring. The time-consuming reference runs, which are therefore only carried out on a random sample basis, no longer have to be performed only cyclically, but can be carried out as and when required.

The monitoring quality increases due to the close time monitoring and the non-productive times can be advantageously reduced. This has the consequence that the number of workpieces that are not properly machined (due to worn or defective machine components) can be reduced. Furthermore, the analysis of the cause of the defect is considerably simplified and provides good conditions for preventive machine maintenance (“predictive maintenance” concept).

Another advantage is that causes, especially of sudden wear, can be determined much more easily and attributed much more precisely.

Another advantage is that the availability of the machine for the effective machining of the workpiece can be increased, since otherwise available non-productive times can be used for test runs, thus reducing or avoiding unplanned machine downtime with the method described.

Finally, it is advantageous that critical temperature changes of the machine can be avoided.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 schematically shows the wear progression of a component of a gear grinding machine, where a wear index is plotted over time,

FIG. 2 schematically shows the wear progression of a component of the machine, where a wear index is plotted over a number of measurements,

FIG. 3 schematically shows a flow chart of how criteria for performing a reference run of the machine are determined,

FIG. 4 schematically shows the concept for the data exchange that is provided for in accordance with an embodiment of the proposed method,

FIG. 5 schematically shows the course over time for three machine axes, with rectangles marking the areas in which test runs are planned, and

FIG. 6 schematically shows a flow diagram for implementing the proposed concept according to a possible embodiment.

### DETAILED DESCRIPTION OF THE INVENTION

The following explanations are based on the described concept, according to which a test run is carried out on at least one machine axis, in particular during gear grinding, in a time segment of the machining phase in which the tool is not in contact with the workpiece. In the course of this test run, the machine axis is actuated in accordance with at least one predefined operating parameter and the reaction of the machine axis to the operating parameter is recorded. The recorded value is subjected to an evaluation by a monitoring device. A signal is output by the monitoring device if the evaluation has shown that the value is outside a permissible range. In this case, there is an irregularity in the machine, which can be attributed in particular to corresponding wear. Therefore, a reference run is then carried out in which all axes of the machine are operated according to a defined programme and these are checked.

In contrast to the previously known procedure, all or at least some of the idle strokes and acceleration phases of the axes are now used to evaluate the machine condition. In principle, all movements during the machining process (in particular the dressing of the tool, the alignment of the workpiece, etc.) can be used for this, in which the workpiece and tool are not in contact.

If there are abnormalities in the signals during the idle strokes, either a reference run can be started automatically (to determine precise values) or a message can be output on the control system that a reference run should be carried out. Furthermore, it is possible to stop the machine to prevent consequential damage.

This means that additional information on the machine status is recorded time-neutral, enabling virtually complete monitoring and that very quickly after detection of unusual values corresponding measures can be initiated; thus, it can be preventing that workpieces are produces which are scrap.

Furthermore, a comprehensive preventive machine maintenance concept (“Predictive Maintenance”) can be installed.

This is particularly advantageous in the case of sudden wear, so that it can be recognised promptly that, for example, machine components need to be replaced. If necessary, a prediction can be made here for the optimal time for a measure by extrapolating the characteristic values.

During phases of the workpiece machining in which the tool does not engage the workpiece, in particular when dressing the tool, when balancing, when swivelling a rotary table or during other machine movements that are necessary for the machining cycle, data from the individual axes is recorded.

These idle strokes (i.e. machine movements in which the tool does not engage with the workpiece) may be, in particular, an idle stroke during finishing dressing (Y-axis) or rough dressing, the infeed during dressing and grinding (X-axis), an idle stroke during grinding (Z-axis) or the approach to the base position for balancing or spinning. Furthermore, acceleration or deceleration phases of the machine axes come into consideration. Also, well suited are those phases of the machining process in which balancing, spinning, alignment of the workpiece, swivelling of a tower (of a rotary table) for dressing and a workpiece change take place.

The recorded measurement signals may be signals from an accelerometer mounted on a machine component, internal control signals (such as currents or control differences), and other signals from existing sensors (for example, from a current clamp and an encoder).

Characteristic values can be calculated to analyse the signals (e.g. a wear index). It is also possible to use the signal curves and evaluate them using neural networks.

The processing of signals preferably takes place on an industrial PC.

The signal curves, evaluations and analyses can be stored in a database locally on the PC. Furthermore, there is the option of storing and evaluating the data in the cloud.

The proposed concept can be used for specific assemblies, machines or components, or also across multiple machines. An approach across different machine types is also conceivable.

Regardless of the scope of the proposed concept, there are always idle strokes for all machining-relevant axes. These can occur during process preparation, during the actual grinding process, during dressing or when the process is completed.

Individual axes (especially the Y-axis) are particularly important for the quality of the grinding process. Monitoring of this axis can be carried out as follows: During the dressing process, the standard dressing technology involves a no-load stroke during finishing dressing (two or more dressing strokes—oscillation inactive) or a no-load stroke during roughing dressing (an odd number of dressing strokes). During the idle stroke, the axis moves at a defined speed over almost the entire traverse range. Similarly, rotary axes (for example during the centrifugal process after dressing) can be relevant. Test runs as described can then be carried out on all these axes. Of course, other idle strokes in other parts of the machining process are also helpful to check various machine components, equivalent to the dressing process.

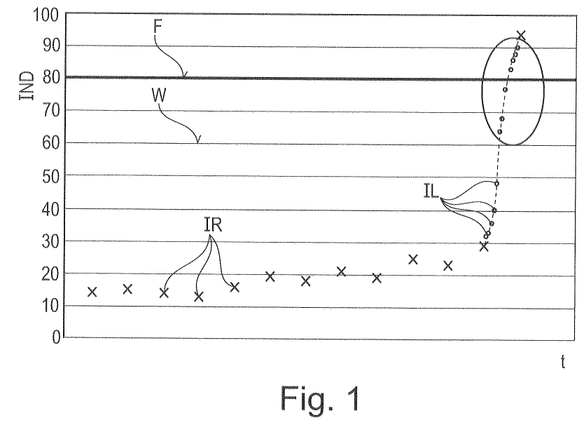

FIG. 1 shows a wear index IND over time t, which led to a respective reference index IR in the course of reference runs; the respective reference index IR determined is marked with a cross. Regarding the wear index, it should be noted that this is a value that can be calculated from various values or signals that are relevant or typical for wear.

The time between two reference runs is, for example, one week. The wear index must be below a warning limit W to be considered safe. If it is still higher than an error limit F, it is to be expected that it will no longer be possible to produce workpieces properly.

A wear index is recorded at much shorter time intervals during idle strokes IL, with this only being entered as an example for the times between the last two reference indices IR; the respective wear index determined during empty strokes IL is marked with a dot. In comparison to the reference indices IR, which are only determined at relatively large time intervals, a large number of wear indices are determined during idle strokes IL; the latter are preferably determined constantly during the machining process.

It can be seen that there is a sudden increase in wear between the penultimate and last reference index IR entered, since the penultimate reference index is still well below the warning limit W, but the next reference index is already above the error limit F. Consequently, the wear that has occurred on the machine axis concerned here could only be detected when a number of workpieces have already been produced and would therefore be scrap. However, the proposed method and the much larger number of wear indices during idle strokes can be used to determine that the wear index IND is rising relatively sharply, so that maintenance measures can be taken before the warning limit W is reached.

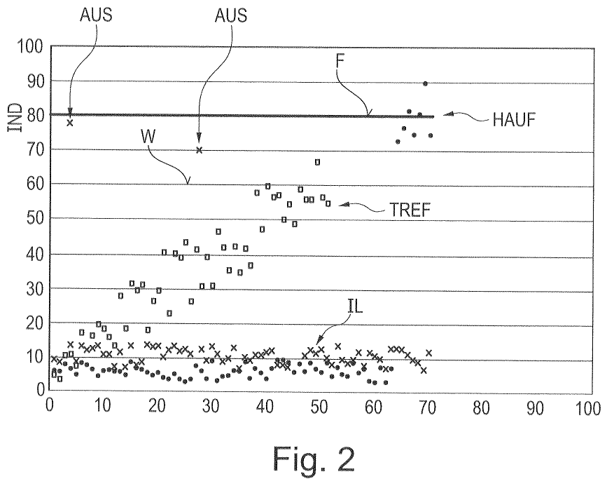

FIG. 2 illustrates that a statistical or trend-based evaluation is also recommended when monitoring a wear index IND. It shows how the size of the wear index IND is represented over the number of measurements for three different machine axes or reactions of the same to a given operating parameter (represented by dots, crosses or squares). It can be seen that the machine axes or their reactions to a given operating parameter behave inconspicuously for the axes marked with a dot and with a cross during the idle strokes IL and are at a low level of the wear index IND. However, it can be seen that the wear index IND of the axis marked with a square gradually increases, so that a trend TREF for a reference run arises here.

Outliers, marked AUS, that may occur are not taken into account in the statistical analysis. Meanwhile, the wear index IND of the axis marked with dots shows from the 64th measurement that there is an accumulation of HAUF at a significantly increased value of the wear index, indicating that there is a sudden significant increase in wear for this machine axis.

In the present case, it is therefore taken into account that an algorithm is used that only initiates a reference run under certain circumstances or indicates that one should be carried out. The informative value of the signals from the test run is significantly lower than that of the signals from the reference runs due to various influencing factors. In this respect, a reference run is not always carried out if a limit is exceeded during a test run, but only if a certain accumulation of abnormalities is detected or a corresponding trend is recognisable. The stored algorithm for selecting whether a reference run is carried out is preferably configurable and/or self-learning.

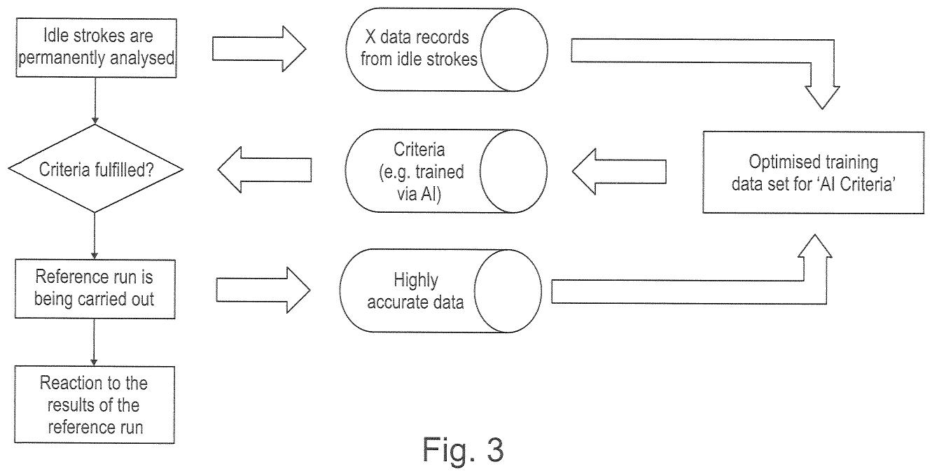

FIG. 3 shows how the criteria for performing a reference run can be optimised. In the manner explained, operating parameters are permanently analysed during the idle strokes of the machine axes and checked to see if the values lie within the specified limits (“criteria met?”). If this is not the case, a reference run is performed and the system responds accordingly.

The data sets that can be obtained from the idle strokes, but equally the precise (highly accurate) data from the reference runs, are subjected to a “machine learning” concept as part of an algorithm, in which an optimised training data set is generated by continuous labelling, which in turn can be used when checking the data obtained during the idle strokes.

So, another aspect of the proposed approach is that a self-learning algorithm is used that optimises the correlations between the analysis of the test run and the results of the reference run after each reference run.

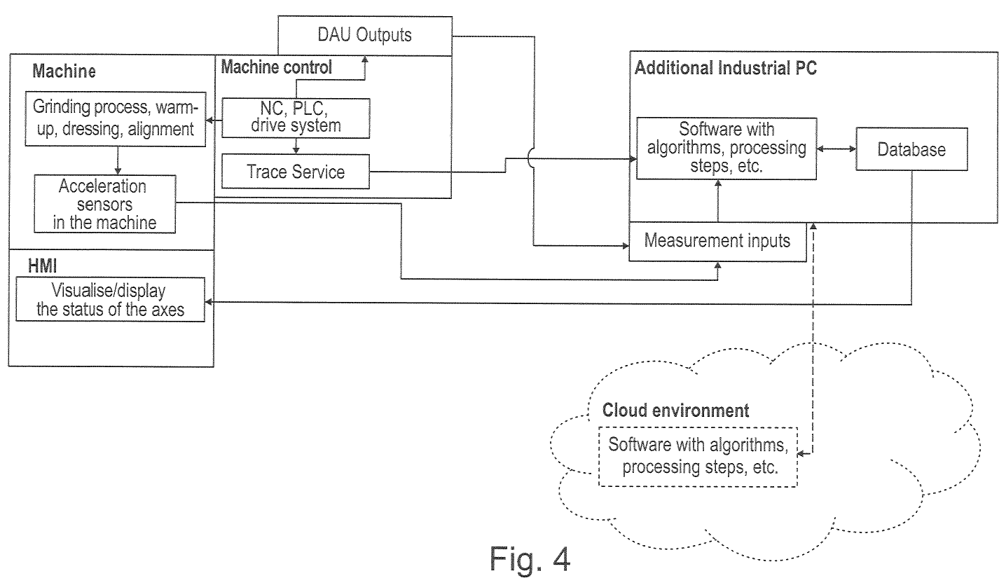

FIG. 4 schematically illustrates the data processing concept for a possible implementation of the proposed method. The left-hand side of the figure shows a schematic of the machine in which the grinding process, warm-up, dressing and alignment of workpieces takes place. During the respective processes, acceleration sensors can be used to determine whether the machine is in proper working order. A corresponding display can be provided via a human-machine interface (HMI).

The machine control system controls the processes and drive and/or vibration data is transmitted to an additional PC via digital-analogue converter outputs (DAU), traces, sensors or other data from the process.

The PC contains software with the appropriate algorithms to evaluate the received data. For this purpose, the values recorded by the acceleration sensors and/or analogue measuring outputs are transmitted to measuring inputs that are made available to the software. The software also connects to a database where stored process data is stored.

The PC can be connected to a cloud.

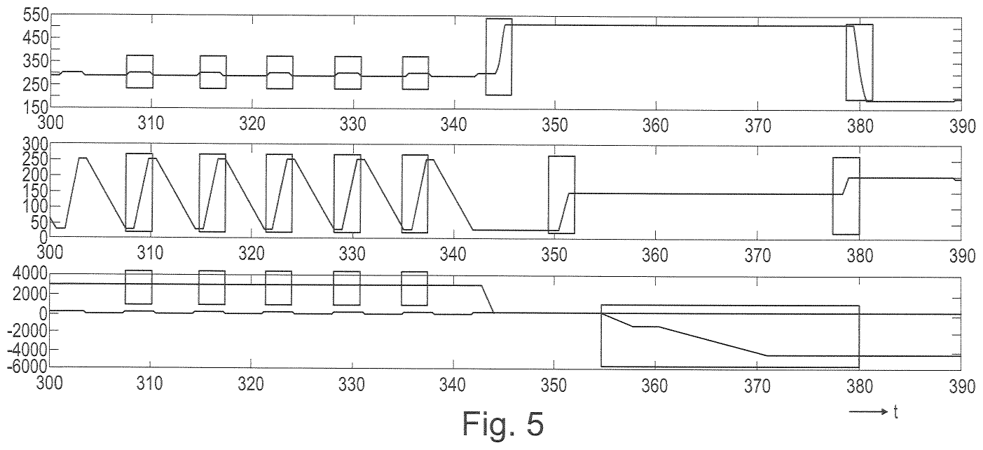

FIG. 5 schematically shows the movements of three axes, with their course over time. Rectangles mark areas in which there is no engagement between the tool and the workpiece due to the process, and which are therefore periods during which test runs can be carried out.

The relevant signals measured here are the power consumption of the drive of the axis (here: the Y-axis of the machine), the control difference in the controller and the acceleration measured by the acceleration sensor. These parameters are those that are typically present in the machine anyway when recording measured values to monitor the dressing process.

The idle stroke can be identified by means of internal control signals (counter for dressing stroke, dressing stage, etc.) and the assigned position of the axis (via an integrated scale); the corresponding signals can be “cut out” (areas marked with rectangles in FIG. 5).

The signals are evaluated by calculating statistical characteristic values during the constant run, but also by “machine learning” algorithms during the acceleration and deceleration phases. It can also be advantageous to choose a “machine learning” approach for the evaluation of the constant run.

The calculated wear value (see wear index IND in FIGS. 1 and 2) is stored in a database and compared with previously defined limit values and/or taught-in limits in order to trigger a reference run if it is exceeded.

The limit values for this (with automatically taught-in limits) are therefore determined from previous idle strokes and reference runs.

It should be noted that, as already mentioned, the signal quality of the idle strokes during a test run is usually poorer than that of a reference run. Therefore, algorithms are preferably used to assess whether a reference run is necessary, in particular by means of statistical approaches or by using “machine learning” concepts (in particular by means of similarity analyses, which can lead to the modification of values).

In this respect, a reduction to purely static values or limits is not necessary.

As already mentioned, if a reference run is triggered, the highly accurate results of the same can be correlated with the results of the idle strokes, thus optimising the dynamic limits.

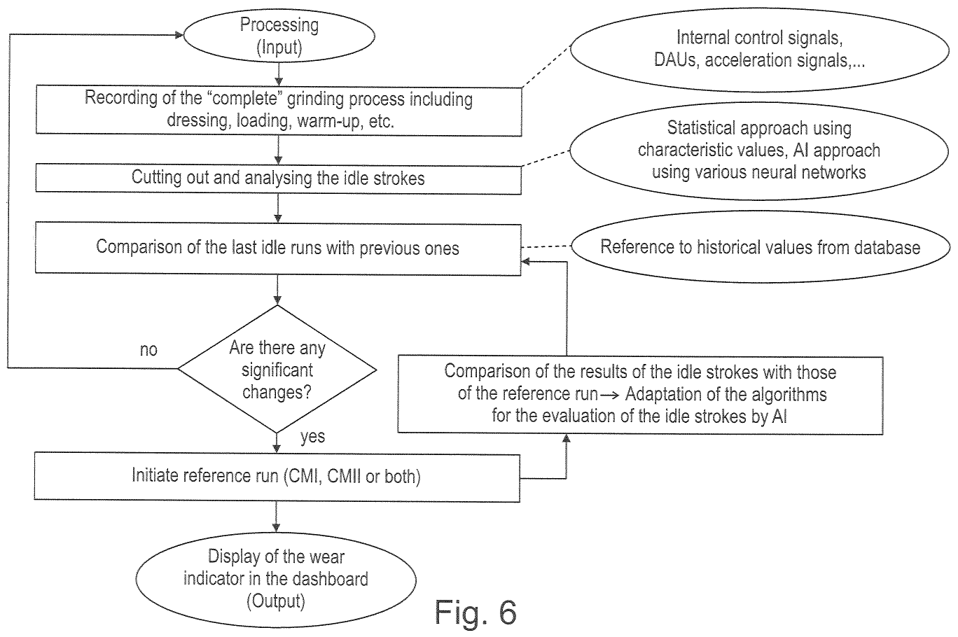

FIG. 6 shows a flow chart that exemplifies this approach.

While specific embodiments of the invention have been shown and described in detail to illustrate the inventive principles, it will be understood that the invention may be embodied otherwise without departing from such principles.

We claim:

1. A method for hard-finishing a workpiece having a gearing or a profile on a hard-finishing machine, wherein the hard-finishing machine has a number of machine axes which are actuated under NC control for machining the workpiece, in which method the workpiece is received on a workpiece spindle and is machined by means of a tool received on a tool spindle machined by bringing the tool into engagement with the workpiece, wherein the workpiece machining phase begins with the introduction of the workpiece into the hard-finishing machine and ends with the removal of the machined workpiece from the hard-finishing machine,
wherein at least in a temporal segment of the machining phase in which the tool is not in engagement with the workpiece, a test run is carried out on at least one machine axis,
wherein the machine axis is driven during the test run, wherein a value is specified for at least one drive parameter for which a nominal value of the movement of the machine axis is expected,
wherein the actual value of the movement of the machine axis is detected,
wherein a comparison between the nominal value and the actual value is carried out by a monitoring device, and
wherein a signal is output by the monitoring device if
a) the comparison between the nominal value and the actual value has shown that the difference between the nominal value and the actual value is outside of an admissible range, or
b) the comparison between the nominal value and the actual value has shown that the difference between the nominal value and the actual value has a value that, compared to previously recorded values of the difference, indicates that the difference has left an admissible tolerance range.

2. The method according to claim 1, wherein the at least one temporal segment of the machining phase lies within the time interval in which the workpiece is received on the workpiece spindle.

3. The method according to claim 1, wherein the test run takes place during an idle stroke in which the tool is moved relative to the workpiece without the tool engaging in the workpiece.

4. The method according to claim 1, wherein the test run takes place during an acceleration or rotational acceleration process and/or during a braking process of a machine axle.

5. The method according to claim 1, wherein the test run takes place during a dressing phase in which the tool is dressed, and/or during a phase in which the workpiece is aligned for machining in the hard-finishing machine, and/or during a phase in which a balancing operation is carried out, and/or in a phase in which a loading or unloading operation is carried out.

6. The method according to claim 1, wherein the signal is not output until a statistical evaluation of a number of detected values has been carried out.

7. The method according to claim 1, wherein the evaluation of the detected values is carried out by means of an algorithm which takes into account empirical values in the context of machine learning.

8. The method according to claim 1, wherein the detected value is the acceleration detected by an acceleration sensor, and/or the current with which a machine axis is driven, and/or a control difference which occurs during the control of the machine axis, and/or a signal which provides an indication of a deviation between the nominal value and the actual value.

9. The method according to claim 1, wherein the output of the signal of the monitoring device, in the event that the assessment has shown that the value is outside of an admissible range, causes a reference run of the hard-finishing machine to be carried out, in which all machine axes are actuated without the tool engaging with the workpiece.

10. The method according to claim 1, wherein the method is a gear grinding method.
